(19) United States
(12) Patent Application Publication
(10) Pub. No.: US 2021/0101358 A1
(43) Pub. Date: Apr. 8, 2021

(54) OUT OF SITE

(71) Applicants: Raymond Phillips, Greeley, CO (US); Bobby Christenson, Greeley, CO (US)

(72) Inventors: Raymond Phillips, Greeley, CO (US); Bobby Christenson, Greeley, CO (US)

(21) Appl. No.: 16/595,172

(22) Filed: Oct. 7, 2019

(51) Int. Cl. B32B 1/02; B32B 15/082; B32B 7/12

(52) U.S. Cl. CPC B32B 1/02; B32B 15/082; B32B 2439/40; B32B 2250/02; B32B 2451/00; B32B 7/12

(57) ABSTRACT

This disclosure is directed to wraps, including vinyl wraps, that can be placed around an industrial site including an oil and gas site and/or tank to camouflage the site. The wraps may contain landscape scenes or custom pictures that enable the industrial site, or the oil and gas site and\or tank, to blend in with the surrounding environment.

### BACKGROUND OF THE DISCLOSURE

### Field of the Invention

This disclosure relates to products and methods for camouflaging objects. More specifically, for camouflaging larger sites on a landscape or property. In a specific embodiment, a tank at an oil and gas site is contemplated.

### Description of the Related Art

Oil and gas sites, as well as other industrial structures, on a property are becoming a more serious problem as these sites are being placed closer and closer to residential areas. Unsightly oil and gas sites can negatively impact property values in the surrounding area. Accordingly, improved products and methods for camouflaging industrial sites including oil and gas sites are needed.

Presently, industrial sites including oil and gas sites on a property are mainly camouflaged by painting the structures, for example, brown or tan. These methods are undesirable because painting does not necessarily blend the structure into a landscape and paint is also difficult to remove.

### SUMMARY OF THE INVENTION

This disclosure is directed to wraps, including vinyl wraps, that can be placed around equipment at an industrial site including an oil and gas site and/or tank to camouflage the site and/or tank. The wraps may contain landscape scenes or custom pictures that enable the industrial site, or the oil and gas site and\or tank, to blend in with the surrounding environment.

Other features and aspects will be apparent from the following detailed description, the drawings, and the claims.

### BRIEF DESCRIPTION OF THE DRAWINGS

FIG. 1A shows one embodiment of a tank at an oil and gas site.

FIG. 1B shows one embodiment of a camouflaged tank at an oil and gas site.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

This disclosure generally describes products and methods for hiding equipment at industrial sites including oil and gas production sites with tanks with a plastic wrap, preferably a vinyl wrap. The wrap does not need open flames to be applied to a site or a tank and does not need separators. This allows industrial sites, including oil and gas production sites with tanks, to blend in with the surrounding landscape and environment.

A picture or image can be applied to an outer surface of the wrap that enables a structure to be camouflaged. The picture or image is variable and can include pictures of existing, nearby, or similar landscape scenes. The picture or image can also generally be anything that an owner or local community desires. The wraps are generally site-specific.

The wrap may be a vinyl wrap and may be pressure adhesive applied. This obviates the need for open-flames for application which is not desirable, in particular, at an oil and gas production site. The inventive wrap also does not leave adhesive residue behind which may be difficult to remove once the wrap is taken down. The wraps may completely or partially cover the site and\or the tank.

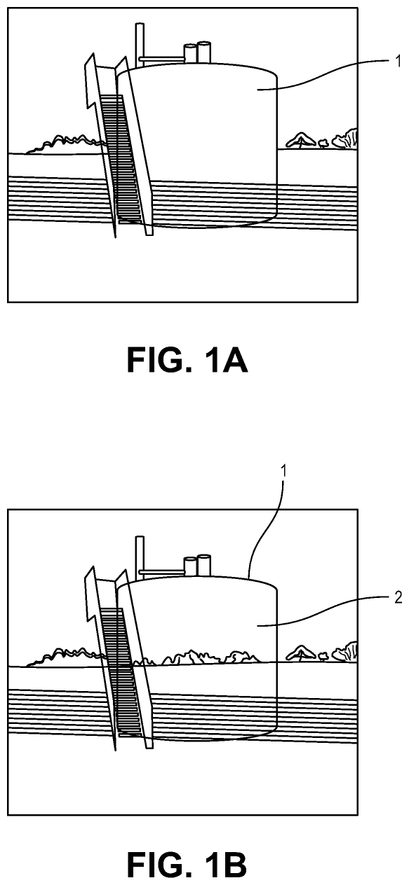

FIG. 1A shows a tank 1 at an oil and gas site before it has been camouflaged.

FIG. 1B shows a tank 1 of an oil and gas site after it has been camouflaged by an inventive vinyl wrap 2 with a landscape scene on its outer surface.

While this disclosure includes specific examples, it will be apparent after an understanding of the disclosure of this application has been attained that various changes in form and details may be made in these examples without departing from the spirit and scope of the claims and their equivalents.

What is claimed is:

1. A wrap for an oil and gas site including a tank comprising:
a flexible, vinyl, material attachable to the tank by pressure adhesive having an inner surface and an outer surface;
wherein an image is applied to the outer surface.

2. The wrap for an oil and gas site of claim 1, wherein the image camouflages the tank.

3. The wrap for an oil and gas site of claim 1, wherein the image is a landscape scene.

4. A method for camouflaging equipment including a tank at an oil and gas site comprising:
wrapping and camouflaging the tank with a flexible, vinyl, material of claim 1; and
attaching the flexible, vinyl, material to the tank via the pressure adhesive.

5. The method of claim 4, wherein the tank is completely wrapped with the flexible, vinyl, material.

6. The method of claim 4, further comprising other equipment at the oil and gas site being wrapped and camouflaged.
